(19) United States
(12) Patent Application Publication
(10) Pub. No.: US 2002/0190854 A1
(43) Pub. Date: Dec. 19, 2002

(54) Deceleration light indicator and method therefor

(76) Inventor: Grant Swan, Phoenix, AZ (US)

Correspondence Address: WEISS & MOY PC, 4204 NORTH BROWN AVENUE, SCOTTSDALE, AZ, 85251, US

(21) Appl. No.: 10/000,231

(22) Filed: Nov. 30, 2001

Related U.S. Application Data
(60) Provisional application No. 60/297,955, filed on Jun. 13, 2001.

(51) Int. Cl. B60Q 1/50

(52) U.S. Cl. 340/467; 340/479

(57) ABSTRACT

A deceleration light warning system has a pressure sensor monitor coupled to an acceleration pedal of the vehicle. The pressure sensor monitor is used for monitoring pressure applied to the acceleration pedal. A controller is coupled to the pressure sensor. The controller is used for receiving a signal from the pressure sensor and for calculating the pressure applied to the acceleration pedal. A light warning system is coupled to the controller and to the vehicle. The light warning system is used for receiving a first signal from the controller to illuminate when the pressure on the acceleration pedal decreases and for receiving a second signal from the controller to deilluminate when the pressure on the acceleration pedal is one of a constant or increases.

### BACKGROUND OF THE INVENTION

1. Field of the Invention

This invention relates to automotive vehicles, and more specifically, to a deceleration light indication system which will provide advance notice to following traffic that the vehicle is decelerating.

2. Description of the Prior Art

Brake light systems to indicate a stopping operation of a vehicle have been in use for many years. In the past, brake light systems operated by having a signal control switch activated by depression of the brake pedal. The control switch sent a signal which illuminated the taillights of the vehicle to indicate that the brake pedal was depressed. Presently, brake light systems sense the buildup of hydraulic pressure, or air pressure, in the system. When there is a measurable increase in the pressure, a signal is sent which illuminates the taillights of the vehicle.

Brake systems were designed for warning traffic participants who are following a leading vehicle that the driver of the leading vehicle was applying the brakes. The brake lights of the vehicle only shine on actuation of the foot brake and not whenever the vehicle coasts along, that is to say on deceleration because the driver takes his foot off the accelerator pedal. By giving drivers an instantaneous notification that a vehicle is decelerating, fewer rear end collisions will occur.

A further disadvantage of a customary brake light is the fact that the warning caused by the light being turned only continues as long as braking is taking place or, respectively, the brake pedal is depressed. However by no longer braking, the danger of a rear end collision is not banished, since the speed differential in relation to the following vehicle owing to the braking operation is still present. On being turned off, the brake light creates the erroneous impression in fact that the danger no longer exists.

Therefore a need existed to provide a vehicle deceleration warning system. The deceleration warning system must be able to provide fairly instantaneous notification that a vehicle is decelerating.

### SUMMARY OF THE INVENTION

In accordance with one embodiment of the present invention, it is an object of the present invention to provide a vehicle deceleration warning system.

It is another object of the present invention to provide a deceleration warning system that is able to provide fairly instantaneous notification that a vehicle is decelerating.

### BRIEF DESCRIPTION OF THE PREFERRED EMBODIMENTS

In accordance with one embodiment of the present invention a deceleration light warning system for a vehicle is disclosed. The deceleration light warning system has a pressure sensor monitor coupled to an acceleration pedal of the vehicle. The pressure sensor monitor is used for monitoring pressure applied to the acceleration pedal. A controller is coupled to the pressure sensor. The controller is used for receiving a signal from the pressure sensor and for calculating the pressure applied to the acceleration pedal. A light warning system is coupled to the controller and to the vehicle. The light warning system is used for receiving a first signal from the controller to illuminate when the pressure on the acceleration pedal decreases and for receiving a second signal from the controller to deilluminate when the pressure on the acceleration pedal is one of a constant or increases.

In accordance with another embodiment of the present invention a method for a vehicle to provide an indication of deceleration comprising the steps of: providing a system for measuring pressure applied to an acceleration pedal of the vehicle; illuminating warning lights when pressure decreases on an acceleration pedal of the vehicle; and deilluminating the warning lights when pressure on the acceleration pedal is one of a constant or increasing.

The foregoing and other objects, features, and advantages of the invention will be apparent from the following, more particular, description of the preferred embodiments of the invention, as illustrated in the accompanying drawing.

### BRIEF DESCRIPTION OF THE DRAWINGS

The novel features believed characteristic of the invention are set forth in the appended claims. The invention itself, as well as a preferred mode of use, and advantages thereof, will best be understood by reference to the following detailed description of illustrated embodiments when read in conjunction with the accompanying drawings, wherein like reference numerals and symbols represent like elements.

FIG. 1 is an elevated front view of an acceleration and brake pedal of a vehicle within which the present invention may be embodied.

FIG. 2 is a rear view of a vehicle within which the present invention may be embodied.

FIG. 3 is a simplified functional block diagram of the deceleration warning system of the present invention.

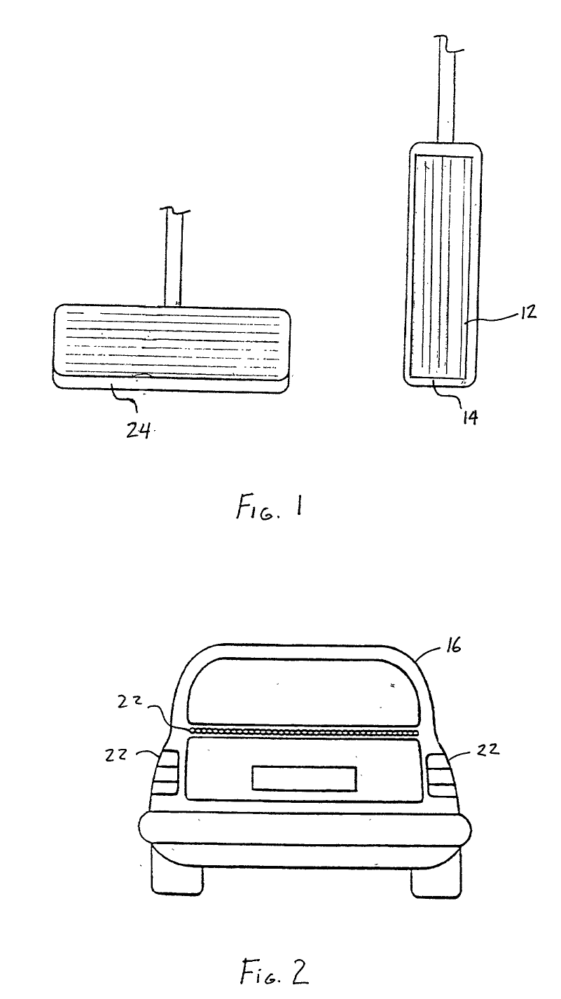

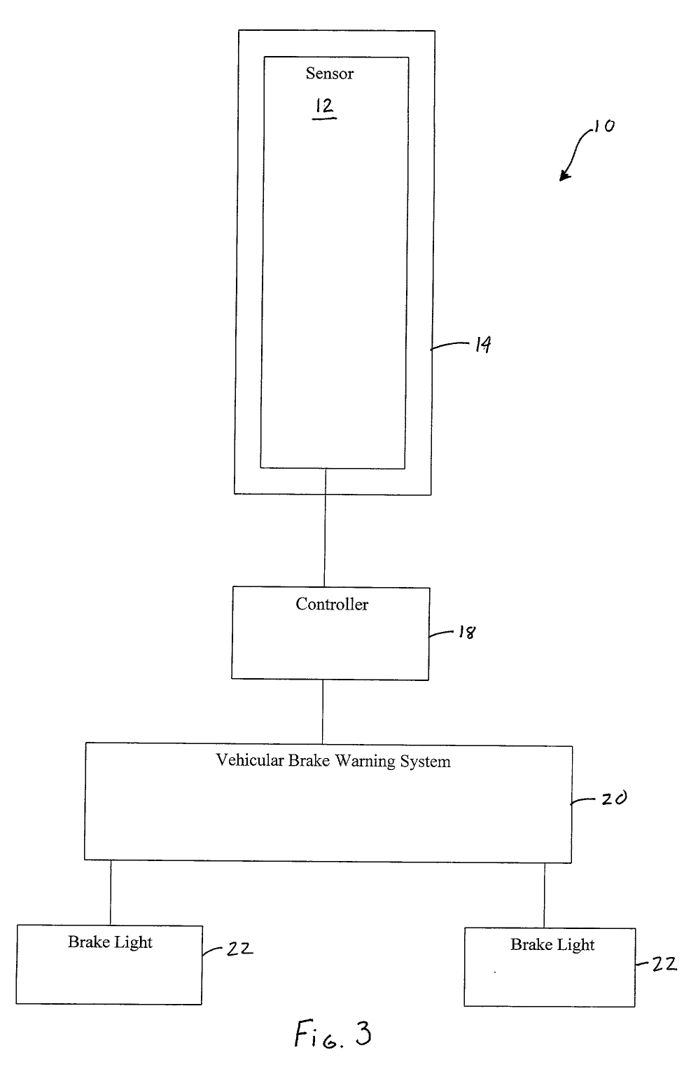

### DETAILED DESCRIPTION OF THE PREFERRED EMBODIMENT

Referring now to the Figures, a vehicle deceleration warning system 10 (hereinafter system 10) is shown. The system 10 may be installed on any new or existing vehicle. The system 10 will provide prompt notice to following vehicles of the deceleration of a lead vehicle. By providing additional notification time of the deceleration of a vehicle, more rear end collisions will be avoided.

The system 10 has a pressure sensor 12 which is installed on the acceleration pedal 14 of a vehicle 16. The pressure sensor 12 will monitor the pressure that is exerted on the acceleration pedal 14. A signal from the pressure sensor 12 is sent to a controller 18. The controller 18 may be a microcontroller, a microprocessor, digital signal processor, or like semiconductor device. However, the listing of the above should not be seen as to limit the scope of the present invention. Other circuitry could be used to perform the function of the controller 18. The controller 18 analyzes the signal to determine whether the driver is applying less pressure to the acceleration pedal 14. If the driver is applying less pressure to the acceleration pedal 14, a signal is sent to the vehicular brake light warning system 20. The vehicular brake light warning system 20 will then send a signal illuminating the brake lights 22. The vehicular brake light warning system 20 is the same one that is presently installed in the vehicle 16. However, instead of the vehicular brake light warning system 20 being activated by depression of the brake pedal 24 or by monitoring the buildup of hydraulic pressure or air pressure in the brake system, the vehicular brake light warning system 20 is activated by a signal from the pressure sensor 12.

In operation, as soon as the vehicle 16 is started, the system 10 will illuminate the brake lights 22. Once the acceleration pedal 14 is depressed, the pressure sensor 12 will send a signal down to the controller 18. The controller 18 will then calculate the pressure applied. If the pressure exceeds a predetermined minimum threshold value, the controller will send a signal to the vehicular brake light warning system 20 which will then send a signal to turn off the brake lights 22. By having the pressure have to exceed a predetermined minimum threshold, this will prevent false signals due to vibrations caused by movement of the vehicle 16.

The controller 18 will continuously monitor the signal coming from the pressure sensor 12 located on the acceleration pedal 12. If the pressure applied to the acceleration pedal 14 decreases by a predetermined minimum threshold amount, the controller 18 will send a signal to the vehicular brake light warning system 20 which will then send a signal to illuminate the brake lights 22. Again, by having the pressure have to exceed a predetermined minimum threshold, this will prevent false signals due to vibrations caused by movement of the vehicle 16. However, as soon as a predetermined incremental amount of pressure is reapplied to the acceleration pedal 14, the controller 18 will send a signal to the vehicular brake light warning system 20 which will then send a signal to turn off the brake lights 22.

For vehicles 16 which have a cruise control system, the system 10 may be coupled to the cruise control system. If the cruise control system is activated, the system 10 will keep the brake lights 22 turned off. As soon as the driver applies pressure to the acceleration pedal 14, the cruise control system is deactivated and the system 10 is reactivated.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A deceleration light warning system for a vehicle comprising, in combination:
a pressure sensor monitor coupled to an acceleration pedal of the vehicle for monitoring pressure applied to the acceleration pedal;
a controller coupled to the pressure sensor for receiving a signal from the pressure sensor and for calculating the pressure applied to the acceleration pedal; and
a light warning system coupled to the controller and to the vehicle for receiving a first signal from the controller to illuminate when the pressure on the acceleration pedal decreases and for receiving a second signal from the controller to deilluminate when the pressure on the acceleration pedal is one of a constant or increases.

2. A deceleration light warning system for a vehicle in accordance with claim 1 wherein the light warning system illuminates when the pressure on the acceleration pedal decreases by a predetermined set amount to prevent false illumination.

3. A deceleration light warning system for a vehicle in accordance with claim 1 wherein the light warning system deilluminates when the pressure on the acceleration pedal increases by a predetermined set amount.

4. A deceleration light warning system for a vehicle in accordance with claim 1 wherein the controller is coupled to a cruise control system of the vehicle and the controller receives a signal from the cruise control system to deactivate the deceleration light warning system when the cruise control system is activated and the controller receives a signal to activate the deceleration light warning system when the cruise control system is deactivated.

5. A deceleration light warning system for a vehicle in accordance with claim 4 wherein the cruise control system is deactivated by applying pressure to the acceleration pedal.

6. A deceleration light warning system for a vehicle in accordance with claim 1 wherein the light warning system illuminates when the vehicle is activated.

7. A method for a vehicle to provide an indication of deceleration comprising the steps of:
providing a system for measuring pressure applied to an acceleration pedal of the vehicle;
illuminating warning lights when pressure decreases on an acceleration pedal of the vehicle; and
deilluminating the warning lights when pressure on the acceleration pedal is one of a constant or increasing.

8. The method of claim 7 further comprising the step of illuminating the warning lights when an ignition of the vehicle is activated.

9. The method of claim 7 further comprising the steps of:
deactivating the system for measuring pressure when a cruise control system is activated; and
activating the system for measuring pressure when the cruise control system is deactivated.

10. The method of claim 7 wherein the step of providing a system for measuring pressure comprises the steps of:
providing a pressure sensor monitor coupled to the acceleration pedal of the vehicle for monitoring pressure applied to the acceleration pedal;
providing a controller coupled to the pressure sensor for receiving a signal from the pressure sensor and for calculating the pressure applied to the acceleration pedal; and
providing a light warning system coupled to the controller and to the vehicle for receiving a first signal from the controller to illuminate the warning lights when the pressure on the acceleration pedal decreases and for receiving a second signal from the controller to deilluminate the warning lights when the pressure on the acceleration pedal is one of a constant or increases.

11. The method of claim 10 wherein the light warning system illuminates when the pressure on the acceleration pedal decreases by a predetermined set amount to prevent false illumination.

12. The method of claim 10 wherein the light warning system deilluminates when the pressure on the acceleration pedal increases by a predetermined set amount.
